(19) United States
(12) Patent Application Publication
(10) Pub. No.: US 2016/0283087 A1
(43) Pub. Date: Sep. 29, 2016

(54) DISPLAY APPARATUS, DISPLAY SYSTEM, CONTROL METHOD FOR DISPLAY APPARATUS, AND COMPUTER PROGRAM

(71) Applicant: SEIKO EPSON CORPORATION, Tokyo (JP)

(72) Inventor: Naoya NISHIMURA, Matsumoto-Shi (JP)

(73) Assignee: SEIKO EPSON CORPORATION, Tokyo (JP)

(21) Appl. No.: 15/077,281

(22) Filed: Mar. 22, 2016

(30) Foreign Application Priority Data
Mar. 25, 2015 (JP) 2015-062213

(51) Int. Cl. G06F 3/0484; G06F 3/0481; G06F 3/14; G09G 5/12; G09G 5/14; G09G 3/00

(52) U.S. Cl. CPC G06F 3/04845; G09G 5/14; G09G 3/002; G06F 3/1454; G09G 5/12; G06F 3/0481; G09G 2370/16

(57) ABSTRACT

A projector includes a projecting section that displays an image in a display region, an interface section connected to an external apparatus, an operation detecting section that detects operation, and a control section that causes the projecting section to display images respectively in the plurality of regions. The plurality of regions include an apparatus associated region associated with the external apparatus to display an image concerning the external apparatus and a processing region where processing for the image displayed in the region is possible. The control section causes, according to the operation detected by the operation detecting section, the display section to display an image displayed in any one of the regions in another one of the regions.

The entire disclosure of Japanese Patent Application No. 2015-062213, filed Mar. 25, 2015 is expressly incorporated by reference herein.

### BACKGROUND

1. Technical Field

The present invention relates to a display apparatus, a display system, a control method for the display apparatus, and a computer program.

2. Related Art

There has been an example in which a plurality of screens are simultaneously displayed in a display apparatus that displays an image (see, for example, JP-A-2011-158844 (Patent Literature 1) and JP-A-2012-63974 (Patent Literature 2)). An apparatus described in Patent Literature 1 clips two images from a captured image and displays the clipped images. A system described in Patent Literature 2 projects slide images on a screen with a projector. In the system, operation can be performed using an electronic pen in an input area of the screen. A stroke is drawn on the basis of the operation of the electronic pen and overwritten and displayed on the slide images.

In Patent Literatures 1 and 2, an example of processing of a plurality of images themselves to be simultaneously displayed is not disclosed. In the configurations disclosed in the literatures, images to be displayed are images extracted from captured images or are slide images, display order of which is determined. This is because it is not easy to match an operation for acquiring and displaying images and processing for the images. Therefore, there has been no proposal for displaying a plurality of images and enabling processing for the images.

### SUMMARY

An advantage of some aspects of the invention is to display a plurality of images and enable processing for the images.

A display apparatus according to an aspect of the invention includes: a display section configured to display an image in a display region; a connecting section connected to an external apparatus; an operation detecting section configured to detect operation; and a control section configured to provide a plurality of regions in the display region and cause the display section to display images respectively in the plurality of regions. The plurality of regions include an apparatus associated region associated with the external apparatus to display an image concerning the external apparatus and a processing region where processing for the image displayed in the region is possible. The control section causes, according to the operation detected by the operation detecting section, the display section to display an image displayed in any one of the regions in another one of the regions.

According to this aspect, it is possible to perform the processing on the image displayed in the region associated with the external apparatus. By displaying, in the processing region, the image in the region associated with the external apparatus and performing the processing, it is possible to display a plurality of images and perform the processing for the images to be displayed without affecting association of the external apparatus and the displayed image.

In the display apparatus according to the aspect, the control section may cause the display section to display an image in the apparatus associated region in a form associated with the external apparatus and may be capable of changing, when the operation detecting section detects operation for moving the image to be displayed in the apparatus associated region to the processing region, the display form of the operated image.

According to this aspect, it is possible to change the display form concerning the image in the region associated with the external apparatus without affecting the association of the external apparatus and the image.

In the display apparatus according to the aspect, when the operation detecting section detects operation for moving the image to be displayed in the processing region to the apparatus associated region, the control section may perform, on the operated image, processing related to the external apparatus associated with the apparatus associated region at a moving destination.

According to this aspect, it is possible to execute the processing related to the external apparatus according to operation for moving an image. It is possible to attain improvement of convenience.

In the display apparatus according to the aspect, the operation detecting section may detect operation on the display region. When the operation detecting section detects operation across the processing region and the apparatus associated region, the control section may detect the operation as operation for moving the image to be displayed in the processing region to the apparatus associated region or operation for moving the image to be displayed in the apparatus associated region to the processing region.

According to this aspect, a user can instruct processing for moving an image to be displayed in a region to another region by performing operation across the plurality of regions.

In the display apparatus according to the aspect, the control section may be capable of associating a plurality of the external apparatuses with at least a singularity of the apparatus associated region and setting the apparatus associated region as a plural-apparatuses associated region. When the operation detecting section detects operation for moving an image to the plural-apparatuses associated region, the control section may perform processing related to each of the plurality of external apparatuses associated with the plural-apparatuses associated region at a moving destination.

According to this aspect, the user can execute processing related to the plurality of external apparatuses by performing simple operation.

In the display apparatus according to the aspect, when causing the display section to display, in the plural-apparatuses associated region, images input from the plurality of external apparatuses associated with the plural-apparatuses associated region, the control section may cause the display section to display the images in display positions corresponding to the respective external apparatuses.

According to this aspect, when the plurality of external apparatuses input images, it is possible to clearly display the plurality of images.

In the display apparatus according to the aspect, the display section may display, in the apparatus associated region or the processing region, an image input from the external apparatus connected to the connecting section. The control section may be capable of changing, without being limited by the external apparatus that inputs the image to be displayed, at least one of a display position and a display size of the image displayed in the processing region by the display section.

According to this aspect, it is possible to change the display position and the display size of the image without being restricted by processing related to the external apparatus.

In the display apparatus according to the aspect, the external apparatus may include an image input apparatus that inputs an image to the connecting section. The display section may display the image input by the image input apparatus in the apparatus associated region associated with the image input apparatus.

According to this aspect, it is possible to process an image according to the external apparatus that inputs the image.

In the display apparatus according to the aspect, the external apparatus may include an image input/output apparatus capable of inputting and outputting an image via the connecting section. The display section may display the image input by the image input/output apparatus in the apparatus associated region associated with the image input/output apparatus. When the operation detecting section detects operation for moving an image to the apparatus associated region, the control section may output the image to the image input/output apparatus associated with the apparatus associated region at a moving destination.

According to this aspect, it is possible to process an image input by the external apparatus and output an image to the external apparatus.

In the display apparatus according to the aspect, the control section may perform processing according to operation for moving an image from the first apparatus associated region to the processing region and may be capable of processing the processed image without being restricted concerning the external apparatus associated with the first apparatus associated region when the operation detecting section detects operation for moving the processed image to the second apparatus associated region.

According to this aspect, it is possible to process an image corresponding to the external apparatus without being restricted concerning the external apparatus by moving the image from a region where the image is displayed to another region.

A display system according to another aspect of the invention includes: a display apparatus; and an external apparatus connected to the display apparatus. The external apparatus outputs an image to the display apparatus. The display apparatus includes: a display section configured to display an image in a display region; a connecting section connected to the external apparatus; an operation detecting section configured to detect operation; and a control section configured to provide a plurality of regions in the display region and cause the display section to display images respectively in the plurality of regions. The plurality of regions include an apparatus associated region associated with the external apparatus to display an image concerning the external apparatus and a processing region where processing for the image displayed in the region is possible. The control section causes the display section to display the image input by the external apparatus in the apparatus associated region and causes, according to the operation detected by the operation detecting section, the display section to display an image displayed in any one of the regions in another one of the regions.

According to this aspect, it is possible to perform the processing on the image displayed in the region associated with the external apparatus. By displaying, in the processing region, the image in the region associated with the external apparatus and performing the processing, it is possible to display a plurality of images and perform the processing for the images to be displayed without affecting association of the external apparatus and the displayed image.

A control method according to still another aspect of the invention is a control method for controlling a display apparatus including a display section that displays an image in a display region and connected to an external apparatus, the control method including: providing, in the display region, a plurality of regions including an apparatus associated region associated with the external apparatus to display an image concerning the external apparatus and a processing region where processing for the image displayed in the region is possible; displaying images respectively in the plurality of regions; detecting operation; and displaying, according to the detected operation, an image displayed in any one of the regions in another one of the regions.

According to this aspect, the display apparatus is capable of performing the processing on the image displayed in the region associated with the external apparatus. By displaying, in the processing region, the image in the region associated with the external apparatus and performing the processing, it is possible to display a plurality of images and perform the processing for the images to be displayed without affecting association of the external apparatus and the displayed image.

A computer program according to yet another aspect of the invention is a computer program executable by a computer that controls a display apparatus including a display section that displays an image in a display region and connected to an external apparatus, the computer program causing the computer to execute: providing, in the display region, a plurality of regions including an apparatus associated region associated with the external apparatus to display an image concerning the external apparatus and a processing region where processing for the image displayed in the region is possible; displaying images respectively in the plurality of regions; and displaying, according to operation, an image displayed in any one of the regions in another one of the regions.

By executing the computer program according to this aspect, the display apparatus is capable of performing the processing on the image displayed in the region associated with the external apparatus. By displaying, in the processing region, the image in the region associated with the external apparatus and performing the processing, it is possible to display a plurality of images and perform the processing for the images to be displayed without affecting association of the external apparatus and the displayed image.

### BRIEF DESCRIPTION OF THE DRAWINGS

The invention will be described with reference to the accompanying drawings, wherein like numbers reference like elements.

FIG. 1 is a diagram showing the configuration and a setting state of a display system.

FIG. 2 is a functional block diagram showing the configurations of apparatuses connected to a projector.

FIG. 3 is a functional block diagram of the projector and a pointer.

FIGS. 4A to 4C are diagrams showing a display example of the display system and an example of operation on a screen.

FIGS. 5A to 5D are diagrams showing a display example of the display system and an example of operation on the screen.

FIGS. 6A to 6C are diagrams showing a display example of the display system and an example of operation on the screen.

FIGS. 7A to 7C are diagrams showing a display example of the display system and an example of operation on the screen.

FIG. 8 is a flowchart for explaining the operation of the projector.

FIG. 9 is a flowchart for explaining the operation of the projector.

FIG. 10 is a flowchart showing the operation of the projector.

FIG. 11 is a flowchart showing the operation of the projector.

### DESCRIPTION OF EXEMPLARY EMBODIMENTS

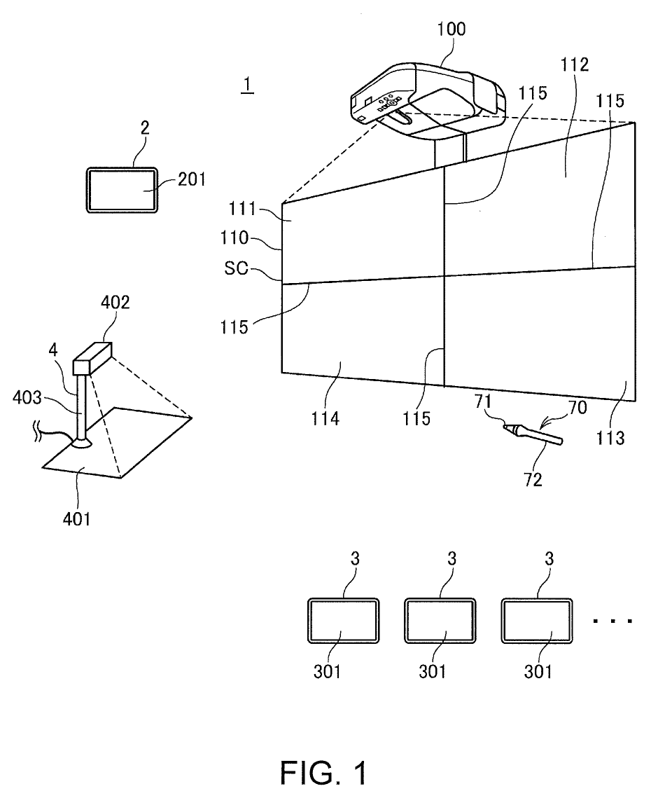

FIG. 1 is a diagram showing the configuration and a setting state of a display system 1.

The display system 1 has a configuration in which a tablet 2 and tablets 3 are connected to a projector 100 (a display apparatus) by a wireless communication line to be capable of performing data communication and a document camera 4 is connected to the projector 100 by wire. The numbers of the tablets 2 and 3 configuring the display system 1 are not limited. In this embodiment, an example is explained in which one tablet 2 and a plurality of tablets 3 are connected.

A user who operates the tablet 2 and a plurality of users who operate the tablets 3 use the display system 1. For example, in an educational site, a user (e.g., a teacher) on a teaching side uses the tablet 2 and users (e.g., students) on a learning side use the tablets 3. The user of the tablet 2 also performs operation using a pointer 70 and performs operation of the document camera 4.

A setting state of the projector 100 is shown in FIG. 1.

The projector 100 is set above or obliquely above a screen SC (an operation surface). The projector 100 projects an image toward the screen SC. The screen SC is a flat plate or a curtain fixed to a wall surface or erected on a floor surface. The invention is not limited to this example. The wall surface can also be used as the screen SC. In this case, the projector 100 is desirably attached to an upper part of the wall surface used as the screen SC.

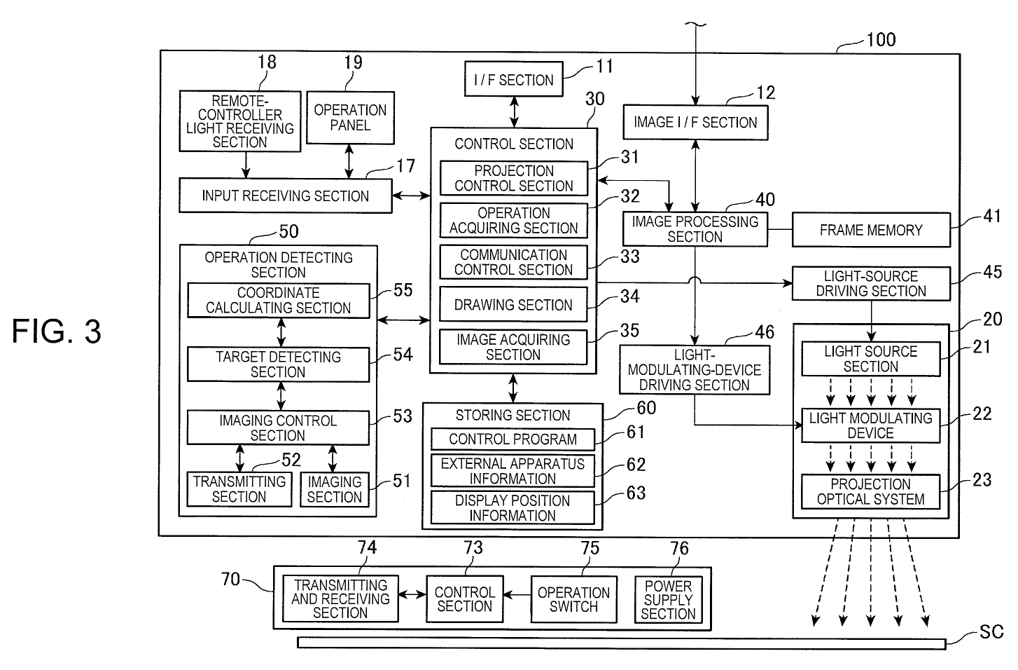

The projector 100 may be connected to an image supply apparatus such as a PC (personal computer), a video reproducing apparatus, a DVD reproducing apparatus, or a Blu-Ray® Disc reproducing apparatus. In this case, the projector 100 projects an image on the screen SC on the basis of an analog image signal or digital image data supplied from the image supply apparatus. The projector 100 may read out image data stored in a storing section 60 (FIG. 3) incorporated therein or a storage medium externally connected thereto and display an image on the screen SC on the basis of the image data.

On the screen SC, a maximum range in which the projector 100 projects an image is represented as a projectable region (a display region) 110. In an example shown in FIG. 1, the entire screen SC is the projectable region 110. The size of the projectable region 110 can be adjusted by a zoom function and the like of the projector 100. The projectable region 110 may be smaller than the screen SC.

The projector 100 can divide the projectable region into a plurality of regions and project images independently on the regions. In the example shown in FIG. 1, the projectable region 110 is divided into four regions 111, 112, 113, and 114. Region boundaries 115 segmenting the regions are located in the longitudinal (vertical) direction center and the lateral (horizontal) direction center of the projectable region 110 in a state shown in FIG. 1. However, the positions of the region boundaries 115 can be moved as explained below.

The projector 100 in this embodiment displays, in the regions 111, 112, 113, and 114, images based on image data transmitted by the tablets 2 and 3, an image based on image data transmitted by the document camera 4, an image drawn by the projector 100 according to operation by the pointer 70, and the like.

The projector 100 has a function of detecting operation by a user on the screen SC. The user holds a shaft section 72 of the pointer 70 of a pen type with a hand and performs operation on the screen SC with a distal end portion 71 of the pointer 70. The operation includes operation for designating (pointing) a position on the screen SC with the distal end portion 71 and operation for continuously pointing different positions on the screen SC with the distal end portion 71. The operation for pointing a position on the screen SC is operation for keeping the distal end portion 71 of the pointer 70 in contact with the screen SC for a fixed time. The operation for continuously pointing different positions on the screen SC is operation for moving the distal end portion 71 while keeping the distal end portion 71 in contact with the screen SC.

The projector 100 detects the operation performed by the user with the pointer 70 and reflects the detected operation on a displayed image on the screen SC. For example, the projector 100 realizes, on the basis of a coordinate of an operation position pointed by the distal en portion 71, GUI (Graphical User Interface) operation for executing a function of the projector 100. The projector 100 has a drawing function for generating a character or a figure along a track of the operation position of the distal end portion 71 and projecting the generated character or figure on the projectable region 110.

The tablet 2 includes, in a flat main body, a touch panel 201 on which touch operation is possible. Similarly, the tablets 3 include, in flat main bodies, touch panels 301 on which touch operation is possible. The touch panels 201 and 301 have a configuration in which a touch panel that detects contact operation is superimposed on a display panel such as a liquid crystal display panel or an organic EL panel functioning as a display screen.

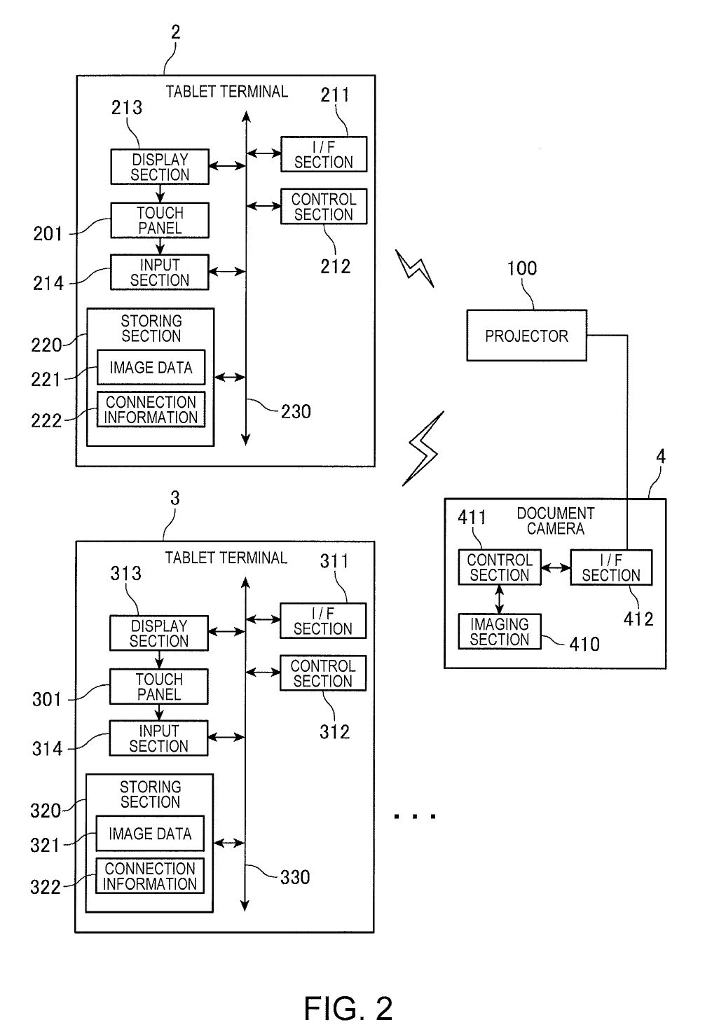

The document camera 4 includes a camera head 402 and a column 403 that supports the camera head 402. The camera head 402 includes an imaging section 410 (FIG. 2) that performs imaging in a downward direction. The document camera 4 images an object placed on a placing surface 401 set below the camera head 402 and transmits captured image data to the projector 100.

FIG. 2 is a functional block diagram of the tablets 2 and 3 and the document camera 4.

The tablet 2 includes an interface section 211 connected to the projector 100. The interface section 211 includes a connector for wired connection for connecting the tablet 2 to an external apparatus by wire. The interface section 211 may include an interface circuit corresponding to the connector. The interface section 211 may include a wireless communication interface. Examples of the connector for wired connection and the interface circuit include connectors and interface circuits conforming to a wired LAN, IEEE1394, USB, MHL (Mobile High-definition Link) (registered trademark), HDMI (registered trademark) (High-Definition Multimedia Interface), and the like. Examples of the wireless communication interface include wireless communication interfaces conforming to a wireless LAN (WiFi®, Bluetooth®, Miracast®, and the like. In this embodiment, the tablet 2 includes a wireless communication interface capable of performing wireless LAN communication.

The tablet 2 includes a control section 212, a display section 213, an input section 214, and a storing section 220. The sections and the interface section 211 are connected by a bus 230 to be capable of performing data communication. The control section 212 includes a CPU, a RAM, and a ROM not shown in the figure. The control section 212 executes a control program stored by the ROM and a control program stored by the storing section 220 to control the sections of the tablet 2.

The display section 213 and the input section 214 are connected to the touch panel 201. The display section 213 displays various screens on the touch panel 201 according to control by the control section 212. The input section 214 detects touch operation on the touch panel 201 and outputs coordinate data indicating the position of the detected operation to the control section 212.

The storing section 220 stores, in a nonvolatile manner, a computer program executed by the control section 212 and various data. The storing section 220 stores image data 221 and connection information 222. The image data 221 is image data for display including an image, characters, and the like displayed on the touch panel 201. The control section 212 can cause the display section 213 to display an image based on the image data 221. The control section 212 can transmit the image data 221 to the projector 100 via the interface section 211.

The connection information 222 includes information for connection to the projector 100 by the interface section 211 through wireless communication. The connection information 222 includes, for example, a MAC (Media Access Control) address, an IP (Internet Protocol) address, a network name, an SSID (Service Set Identifier) of the tablet 2. The connection information 222 may include an SSID, a type of security setting, a password or a passkey, and a terminal name of an apparatus to which the interface section 211 is connected. The security setting can be selected from, for example, WEP (Wired Equivalent Privacy) and WPA (Wi-Fi Protected Access).

The connection information 222 may include information of the items concerning an external apparatus such as the projector 100 connected to the tablet 2 and information of the items concerning the interface section 211.

The control section 212 establishes wireless communication with the projector 100 referring to the connection information 222 and executes data communication by radio with the projector 100. When the control section 212 transmits the image data 221 to the projector 100, the projector 100 receives the image data 221 and projects an image based on the image data 221. The control section 212 can also display, with the display section 213, the image based on the image data 221 transmitted to the projector 100.

The tablet 3 is configured the same as the tablet 2. That is, the tablet 3 includes an interface section 311 connected to the external apparatus such as the projector 100. The configuration of the interface section 311 is the same as the configuration of the interface section 211.

The tablet 3 includes a control section 312, a display section 313, an input section 314, and a storing section 320. The sections and the interface section 311 are connected by a bus 330 to be capable of performing data communication. The control section 312 includes a CPU, a RAM, and a ROM not shown in the figure. The control section 312 executes a control program stored by the ROM and a control program stored by the storing section 320 to control the sections of the tablet 3.

The display section 313 and the input section 314 are connected to the touch panel 301. The display section 313 displays various screens on the touch panel 301 according to control by the control section 312. The input section 314 detects contact operation on the touch panel 301 and outputs coordinate data indicating the position of the detected operation to the control section 312.

The storing section 320 stores, in a nonvolatile manner, a computer program executed by the control section 312 and various data. The storing section 320 stores image data 321 and connection information 322. The image data 321 is image data for display including images and characters displayed on the touch panel 301. The control section 312 can cause the display section 313 to display an image based on the image data 321. The control section 312 can transmit the image data 321 to the projector 100 via the interface section 311.

The connection information 322 includes information for connection to the projector 100 by the interface section 311 through wireless communication. The connection information 322 includes, for example, a MAC address, an IP address, a network name, and an SSID of the tablet 3. The connection information 322 may include a type of security setting, an SSID, a password or a passkey, and a terminal name of an apparatus to which the interface section 311 is connected. The connection information 322 may include information of the items concerning the external apparatus such as the projector 100 connected to the tablet 3 and information of the items concerning the interface section 311.

The control section 312 establishes wireless communication with the projector 100 referring to the connection information 322 and executes data communication by radio with the projector 100. When the control section 312 transmits the image data 321 to the projector 100, the projector 100 receives the image data 321 and projects an image based on the image data 321. The control section 312 can also display, with the display section 313, the image based on the image data 321 transmitted to the projector 100.

The document camera 4 includes the imaging section 410, a control section 411 that controls the imaging section 410, and an interface section 412 connected to the projector 100. In this embodiment, the interface section 412 includes a circuit including a USB connector USB-connected to the projector 100 and a USB device controller. The interface section 412 may be an interface (e.g., a D-Sub) that outputs an analog image signal for display or may be an interface (e.g., a DVI) that outputs digital video data. The interface section 412 only has to be capable of being connected to the projector 100 and transmitting data. The interface section 412 may be connectable to the projector 100 by, for example, wireless communication.

The imaging section 410 is a digital still camera or a digital video camera and is set to include the placing surface 401 (FIG. 1) in an imaging range. The control section 411 causes the imaging section 410 to execute imaging, generates captured image data, and transmits the captured image data from the interface section 412 to the projector 100. The control section 411 may convert the captured image data of the imaging section 410 into an analog image signal or may convert the captured image data to digital video data. The imaging section 410 may be capable of performing zoom and focus adjustment. In this case, the control section 411 controls adjustment of zoom and focus.

The document camera 4 may include an illumination device that illuminates the imaging range of the imaging section 410, that is, the placing surface 401. In this case, the control section 411 controls lighting and extinction of the illumination device.

FIG. 3 is a functional block diagram of the projector 100 and the pointer 70.

The projector 100 includes an interface (I/F) section 11 and an image interface (I/F) section 12 as interfaces connected to the external apparatus. The interface section 11 and the image interface section 12 include connectors for wired connection. The interface section 11 and the image interface section 12 may include interface circuits corresponding to the connectors. The interface section 11 and the image interface section 12 may include wireless communication interfaces. Examples of the connectors for wired connection and the interface circuits include connectors and interface circuits conforming to a wired LAN, IEEE1394, USB, and the like. Examples of the wireless communication interfaces include wireless communication interfaces conforming to a wireless LAN, Bluetooth, and the like. As the image interface section 12, an interface for image data such as HDMI can be used. An interface to which an analog image signal is input such as a D-Sub may be used. The image interface section 12 may include an interface to which sound data is input.

The interface section 11 is an interface that transmits and receives various data to and from an external apparatus such as a PC. The interface section 11 inputs and outputs data concerning projection of an image, data for setting the operation of the projector 100, and the like. A control section 30 explained below has a function of transmitting and receiving data to and from the external apparatus via the interface section 11.

The image interface section 12 is an interface to which digital image data is input. The projector 100 in this embodiment projects an image on the basis of digital image data input via the image interface section 12. Note that the projector 100 may have a function of projecting an image on the basis of an analog image signal. In this case, the image interface section 12 may include an interface for an analog image and an A/D conversion circuit that converts an analog image signal into digital image data.

For example, the tablets 2 and 3 can be connected to the interface section 11. The document camera 4 may be connected either the interface section 11 or the image interface section 12. However, in this embodiment, the tablets 2 and 3 and the document camera 4 are connected to the interface section 11.

The tablets 2 and 3 are connected to a wireless LAN interface of the interface section 11. The document camera 4 is connected to a USB interface.

The projector 100 recognizes, as an image source, an apparatus that inputs image data or an analog image signal among apparatuses connected to the interface section 11 and the image interface section 12.

The projector 100 includes a projecting section 20 that performs optical formation of an image. The projecting section 20 includes a light source section 21, a light modulating device 22, and a projection optical system 23. The light source section 21 includes a light source including a Xenon lamp, an ultra-high pressure mercury lamp, an LED (Light Emitting Diode), or a laser light source. The light source section 21 may include a reflector and an auxiliary reflector that guide light emitted by the light source to the light modulating device 22. Further, the light source section 21 may include a lens group (not shown in the figure) for improving an optical characteristic of projected light, a polarizing plate, or a dimming element that reduces a light amount of the light emitted by the light source on a path leading to the light modulating device 22.

The light modulating device 22 includes, for example, three transmission-type liquid crystal panels corresponding to the three primary colors of RGB. The light modulating device 22 modulates lights transmitted through the liquid crystal panels and generates image light. The light from the light source section 21 is separated into color lights of the three colors of RGB. The color lights are made incident on the liquid crystal panels corresponding to the color lights. The color lights transmitted through the liquid crystal panels and modulated are combined by a combination optical system such as a cross dichroic prism and emitted to the projection optical system 23.

The projection optical system 23 includes a lens group that guides the image light modulated by the light modulating device 22 to the direction of the screen SC and focuses the image light on the screen SC. The projection optical system 23 may include a zoom mechanism that performs enlargement and reduction of a displayed image on the screen SC and a focus adjusting mechanism that performs adjustment of focus. When the projector 100 is a short focus type, the projection optical system 23 may include a concave mirror that reflects the image light toward the screen SC.

The projecting section 20 is connected to a light-source driving section 45 that lights the light source section 21 according to the control by the control section 30 and a light-modulating-device driving section 46 that causes the light modulating device 22 to operate according to the control by the control section 30. The light-source driving section 45 may have a function of performing switching of lighting and extinction of the light source section 21 and adjusting a light amount of the light source section 21.

The projector 100 includes an image processing system that processes an image projected by the projecting section 20. The image processing system includes the control section 30 that controls the projector 100, the storing section 60, an input receiving section 17, an image processing section 40, the light-source driving section 45, and the light-modulating-device driving section 46. A frame memory 41 is connected to the image processing section 40. An operation detecting section 50 is connected to the control section 30. These sections may be included in the image processing system.

The control section 30 controls the sections of the projector 100 by executing a predetermined control program 61. The storing section 60 stores the control program 61 executed by the control section 30. The storing section 60 stores external apparatus information 62 and display position information 63 in a nonvolatile manner. The external apparatus information 62 includes information concerning external apparatuses connected to the interface section 11 and the image interface section 12. The external apparatus information 62 may include information for specifying the external apparatuses. For example, when the tablets 2 and 3 are connected to the interface section 11, the external apparatus information 62 includes various kinds of information for executing communication with the tablet 2 and information for specifying the tablet 2. Specifically, the external apparatus information 62 may include a MAC address, an IP address, a network name, and an SSID of the tablet 2 and a type of security setting, an SSID, a password or a passkey, and a terminal name of wireless communication with the tablet 2. The external apparatus information 62 includes the same information concerning the tablet 3. The storing section 60 may store, as different kinds of information, the external apparatus information 62 concerning the tablet 2 and the external apparatus information 62 concerning the tablet 3. The external apparatus information 62 includes information capable of distinguishing the tablet 2 and the tablet 3. In this embodiment, since the plurality of tablets 3 are connected to the projector 100, the external apparatus information 62 may include information for distinguishing the respective tablets 3. The external apparatus information 62 corresponding to the respective tablets 3 may be stored in the storing section 60 as independent information. The external apparatus information 62 includes information concerning the document camera 4 (FIG. 1) connected to the interface section 11.

The display position information 63 is information for deciding correspondence between the regions 111, 112, 113, and 114 provided in the projectable region 110 and apparatuses connected to the interface section 11 and the image interface section 12. The projector 100 is capable of associating apparatuses connected to the projector 100 with the respective regions 111, 112, 113, and 114. As explained in detail below, in this embodiment, the tablet 2 is associated with the region 111, the document camera 4 is associated with the region 112, and the tablets 3 are associated with the region 114. The display position information 63 includes, for example, information indicating the correspondence relation explained above.

The image processing section 40 processes, according to the control by the control section 30, image data input via the interface section 11 or the image interface section 12 and outputs an image signal to the light-modulating-device driving section 46. Processing executed by the image processing section 40 is discrimination processing for a 3D (stereoscopic) image and a 2D (planar) image, resolution conversion processing, frame rate conversion processing, distortion correction processing, digital zoom processing, color tone correction processing, luminance correction processing, and the like. The image processing section 40 executes processing designated by the control section 30 and performs, according to necessity, processing using parameters input from the control section 30. Naturally, it is also possible to execute a plurality of kinds of processing among the kinds of processing explained above in combination.

The image processing section 40 is connected to the frame memory 41. The image processing section 40 develops, in the frame memory 41, image data input from the interface section 11 or the image interface section 12 and executes the various kinds of processing on the developed image data. The image processing section 40 reads out the image data after the processing from the frame memory 41, generates image signals of R, G, and B corresponding to the image data, and outputs the image signals to the light-modulating-device driving section 46.

The light-modulating-device driving section 46 is connected to the liquid crystal panels of the light modulating device 22. The light-modulating-device driving section 46 drives the liquid crystal panels on the basis of the image signals input from the image processing section 40 and draws images on the liquid crystal panels.

The input receiving section 17 is connected to the remote-controller light receiving section 18 and an operation panel 19 functioning as input devices. The input receiving section 17 detects operation performed via the remote-controller light receiving section 18 and the operation panel 19.

The remote-controller light receiving section 18 receives an infrared ray signal transmitted by a remote controller (not shown in the figure), which is used by the user of the projector 100, according to button operation. The remote-controller light receiving section 18 decodes the infrared ray signal received from the remote controller, generates operation data indicating operation content in the remote controller, and outputs the operation data to the control section 30.

The operation panel 19 is provided in an exterior housing of the projector 100 and includes various switches and an indicator lamp. According to the control by the control section 30, the input receiving section 17 lights and extinguishes the indicator lamp of the operation panel 19 as appropriate according to an operation state and a setting state of the projector 100. When the switch of the operation panel 19 is operated, operation data corresponding to the operated switch is output from the input receiving section 17 to the control section 30.

The operation detecting section 50 detects an operation position by the pointer 70. The operation detecting section 50 includes an imaging section 51, a transmitting section 52, an imaging control section 53, a target detecting section 54, and a coordinate calculating section 55.

The imaging section 51 images an imaging range including at least the projectable region 110 and forms a captured image. The imaging section 51 includes an image pickup device for infrared that images infrared light and an interface circuit and performs imaging by the infrared light. As the image pickup device, both of a CCD and a CMOS can be used. Other devices can also be used. An imaging direction of the imaging section 51 is a direction the same or substantially the same as the direction of the projection optical system 23. An imaging range (an angle of view) of the imaging section 51 covers a range in which the projection optical system 23 projects an image on the screen SC. The imaging section 51 outputs captured image data.

The imaging control section 53 controls the imaging section 51 according to the control by the control section 30 and causes the imaging section 51 to execute imaging. The imaging control section 53 acquires the captured image data of the imaging section 51 and outputs the captured image data to the target detecting section 54. An image of infrared light emitted by the pointer 70 is reflected in the captured image data of the infrared light captured by the imaging section 51.

The transmitting section 52 transmits an infrared ray signal for synchronization to the pointer 70 according to control by the imaging control section 53. The transmitting section 52 includes a light source such as an infrared LED and lights and extinguishes the light source according to the control by the imaging control section 53.

The target detecting section 54 detects the image of the infrared light reflected in the captured image data of the imaging section 51 and detects a coordinate of an operation position of the pointer 70 in the captured image data. The target detecting section 54 determines whether the distal end portion 71 of the pointer 70 is in contact with the screen SC and generates touch information indicating whether the distal end portion 71 is in contact with the screen SC. A method of determining whether the distal end portion 71 of the pointer 70 is in contact with the screen SC is explained below.

The coordinate of the operation position of the pointer 70 detected by the target detecting section 54 is a coordinate in the captured image data of the imaging section 51.

The coordinate calculating section 55 converts the coordinate of the operation position into a coordinate of an operation position on the screen SC. In this embodiment, the coordinate of the operation position is converted into a coordinate on a projected image projected by the projecting section 20. The coordinate on the projected image is affected by various factors such as the distance between the projector 100 and the screen SC, a zoom rate in the projection optical system 23, a setting angle of the projector 100, and the distance between the imaging section 51 and the screen SC. The coordinate calculating section 55 calculates, on the basis of a result of calibration carried out beforehand, a coordinate of an operation position on a displayed image on the screen SC from the coordinate of the operation position in the captured image data. In the calibration, a predetermined pattern image is projected on the screen SC from the projecting section 20 and the displayed pattern image is captured by the imaging section 51. A correspondence relation (a coordinate conversion parameter) between the coordinate in the captured image data and the coordinate on the displayed image on the screen SC is derived on the basis of the pattern image captured by the imaging section 51. The control section 30 can specify, on the basis of the coordinate of the operation position on the projected image, an operation position for a projected image drawn on the frame memory 41.

The pointer 70 includes a control section 73, a transmitting and receiving section 74, an operation switch 75, and a power supply section 76. These sections are housed in the shaft section 72 (FIG. 1). The control section 73 is connected to the transmitting and receiving section 74 and the operation switch 75 and detects an ON/OFF state of the operation switch 75. The operation switch 75 is disposed at the distal end portion 71 of the pointer 70. The operation switch 75 is turned on when the distal end portion 71 is pressed against the screen SC. The transmitting and receiving section 74 includes a light source such as an infrared LED and a light receiving element that receives infrared light. The transmitting and receiving section 74 lights and extinguishes the light source according to control by the control section 73 and outputs a signal indicating a light reception state of the light receiving element to the control section 73.

The power supply section 76 includes a dry cell or a secondary cell as a power supply and supplies electric power to the control section 73, the transmitting and receiving section 74, and the operation switch 75. The pointer 70 may include a power switch for turning on and off the power supply from the power supply section 76.

A method of specifying an operation position of the pointer 70 from the captured image data of the imaging section through mutual communication between the operation detecting section 50 and the pointer 70 is explained.

When detecting operation by the pointer 70, the control section 30 of the projector 100 controls the imaging control section 53 to transmit a signal for synchronization from the transmitting section 52. That is, the imaging control section 53 lights the light source of the transmitting section 52 at a predetermined cycle according to the control by the control section 30. Infrared light cyclically emitted by the transmitting section 52 functions as a synchronization signal for synchronizing the operation detecting section 50 and the pointer 70.

On the other hand, after the supply of the electric power from the power supply section 76 is started and a predetermined initialization operation is performed, the control section 73 of the pointer 70 receives, with the transmitting and receiving section 74, infrared light emitted by the transmitting section 52 of the projector 100. When the infrared light cyclically emitted by the transmitting section 52 is received by the transmitting and receiving section 74, the control section 73 lights, in synchronization with timing of the infrared light, the light source of the transmitting and receiving section 74 (causes the light source to emit light) in a lighting pattern peculiar to the pointer 70 set in advance. The control section 73 switches the lighting pattern of the transmitting and receiving section 74 according to an operation state of the operation switch 75. Therefore, the target detecting section 54 of the projector 100 can determine, on the basis of a sequentially-captured plurality of captured image data, an operation state of the pointer 70, that is, whether the distal end portion 71 is pressed against the screen SC.

The control section 73 repeatedly executes the pattern while the electric power is supplied from the power supply section 76. That is, the transmitting section 52 cyclically transmits an infrared ray signal for synchronization to the pointer 70. The pointer 70 transmits an infrared ray signal set in advance in synchronization with the infrared ray signal transmitted by the transmitting section 52.

The imaging control section 53 performs control for adjusting imaging timing by the imaging section 51 to timing when the pointer 70 is lit. The imaging timing is determined on the basis of timing when the imaging control section 53 lights the transmitting section 52. The target detecting section 54 can specify a pattern of the lighting of the pointer 70 according to whether an image of light of the pointer 70 is reflected in the respective sequentially-captured plurality of captured image data. The target detecting section 54 determines, on the basis of the plurality of captured image data, whether the distal end portion 71 of the pointer 70 is pressed against the screen SC and generates touch information.

The lighting pattern of the pointer 70 can be a lighting pattern including a pattern peculiar to each individual of the pointer 70 or a pattern common to a plurality of the pointers 70 and the pattern peculiar to each individual of the pointer 70. In this case, when images of infrared lights emitted by the plurality of pointers 70 are included in captured image data, the target detecting section 54 can distinguish the respective images as images of different pointers 70.

The control section 30 reads out and executes the control program 61 stored by the storing section 60 to thereby realize functions of a projection control section 31, an operation acquiring section 32, a communication control section 33, a drawing section 34, and an image acquiring section 35 and control the sections of the projector 100.

The projection control section 31 acquires, on the basis of operation data input from the input receiving section 17, operation content performed by the user operating the remote controller. The projection control section 31 controls the image processing section 40, the light-source driving section 45, and the light-modulating-device driving section 46 according to the operation performed by the user and projects an image on the screen SC.

The projection control section 31 controls the image processing section 40 to execute the discrimination processing for a 3D (stereoscopic) image and a 2D (planar) image, the resolution conversion processing, the frame rate conversion processing, the distortion correction processing, the digital zoom processing, the color tone correction processing, the luminance correction processing, and the like. The projection control section 31 controls the light-source driving section 45 according to the processing by the image processing section 40 and controls a light amount of the light source section 21.

The operation acquiring section 32 acquires an operation position of the pointer 70 detected by the operation detecting section 50. In a state in which an image for GUI operation such as a menu bar is displayed in the projectable region 110, when the operation detecting section 50 detects the operation position of the pointer 70, the operation acquiring section 32 specifies an image corresponding to the operation position and detects instruction content. For example, in the state in which the menu bar is displayed, the operation acquiring section 32 specifies an icon in the menu bar corresponding to the operation position of the pointer 70 and detects a function of the specified icon.

The communication control section 33 controls communication between the tablet 2 and the tablet 3 performed via the interface section 11. The communication control section 33 selects one or a plurality of tablets 3 out of the plurality of tablets 3 and performs control for, for example, transmitting image data to the selected tablet(s) 3.

The drawing section 34 draws a character or a figure according to the operation position of the pointer 70 detected by the operation detecting section 50. When the operation acquiring section 32 detects operation for instructing drawing, the drawing section 34 acquires a track of the operation position of the pointer 70 and generates a straight line, a curved line, or a figure (an image) such as a polygon on the basis of the track. A type of the image generated by the drawing section 34 is designated by operation detected by the operation acquiring section 32. The image generated by the drawing section 34 is transferred to the image processing section 40. The image processing section 40 combines the drawn image with an image on the frame memory 41 according to the control by the projection control section 31. Consequently, the image drawn by the drawing section 34 is projected by the projecting section 20.

The image acquiring section 35 acquires image data input from the external apparatuses connected to the interface section 11 and the image interface section 12. When an analog image signal is input from the interface section 11 or the image interface section 12, the image acquiring section 35 acquires digital image data obtained by converting the analog image signal. The image acquiring section 35 acquires the acquired image data in association with the external apparatus at an input source.

The projection control section 31 associates the image data acquired by the image acquiring section 35 with any one of the regions 111, 112, 113, and 114 on the basis of the display position information 63. The projection control section 31 outputs an image based on the image data acquired by the image acquiring section 35 to the image processing section 40 and causes the image processing section 40 to draw the image in the frame memory 41. The image processing section 40 draws the image based on the image data input by the projection control section 31 in a corresponding region in the frame memory 41. In the frame memory 41, an image corresponding to the entire projectable region 110 including the regions 111, 112, 113, and 114 is formed.

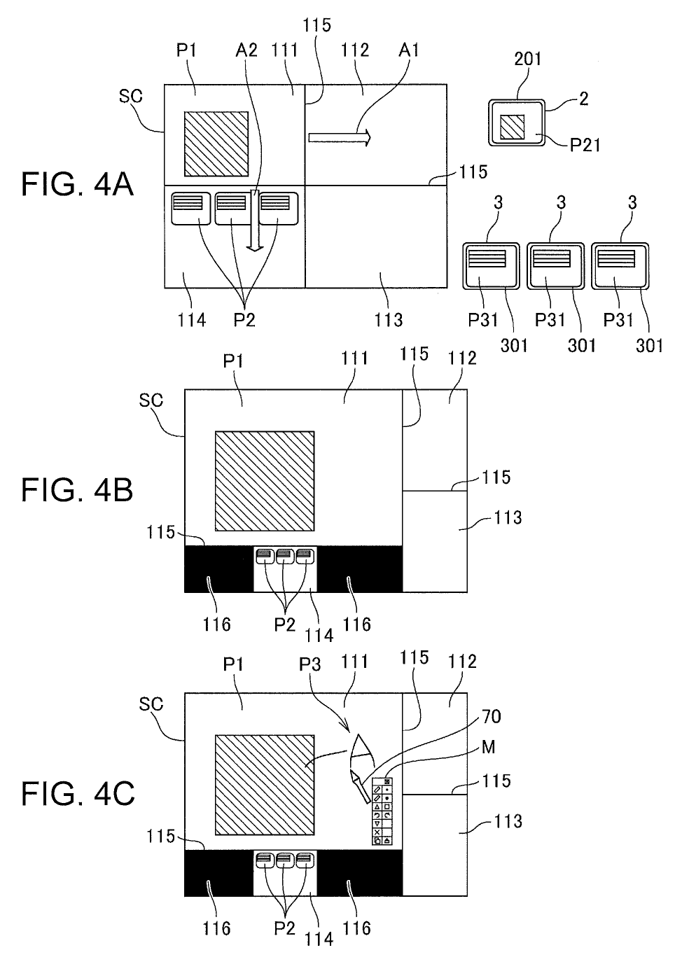

FIGS. 4A to 7C are diagrams showing display examples of the display system 1 and examples of operation on the screen SC.

In the following explanation, an example is explained in which the region 111 of the projectable region 110 is associated with the tablet 2, the region 112 is associated with the document camera 4, and the region 114 is associated with the tablets 3. Therefore, the regions 111, 112, and 114 are equivalent to apparatus associated regions. In this example, the region 113 is a processing region where an image is processed. The plurality of tablets 3 are associated with the region 114. The region 114 is equivalent to a plural-apparatuses associated region. In the projector 100, any one tablet 3 can be associated any one of the regions 111, 112, 113, and 114. However, in an example explained below, all of the plurality of tablets 3 are associated with the region 114.

FIG. 4A shows a display example and an example of operation in an initial state. FIG. 4B shows an example in which display changes according to the operation in FIG. 4A. FIG. 4C shows an example in which the display changes according to drawing operation. In FIG. 4A, the tablets 2 and 3 are shown together with the screen SC.

The display example shown in FIG. 4A is an example in which the tablet 2 and the plurality of tablets 3 and the projector 100 operate. The tablet 2 displays a displayed image P21 on the touch panel 201. The tablets 3 respectively display drawn images P31 on the touch panels 301.

The tablet 2 transmits image data of the displayed image P21 to the projector 100. The respective tablets 3 transmit image data of the drawn images P31 to the projector 100. The projector 100 displays a displayed image P1 same as the displayed image P21 in the region 111 of the screen SC. The projector 100 displays displayed images P2 same as the drawn images P31 in the region 114 in forms corresponding to the respective tablets 3. In the region 114, three displayed images P2 corresponding to the three tablets 3 are displayed. Since the region 114 is the plural-apparatuses associated region, a size for displaying an image of one tablet 3 is restricted. Therefore, the control section 30 may generate image data of thumbnail images (reduced images) on the basis of the image data received from the tablets 3 and display the thumbnail images in the region 114.

In a display state shown in FIG. 4A, when operation for moving the region boundary 115 extending in the longitudinal direction to an arrow A1 direction and operation for moving the region boundary 115 extending in the lateral direction to an arrow A2 direction are performed in order by the pointer 70. Then, the position of the region boundary 115 moves according to the arrows A1 and A2. A state after the movement is shown in FIG. 4B. An entire displayed image including the regions 111, 112, 113, and 114 is drawn in the frame memory 41. Therefore, the projection control section 31 can easily change the positions of the region boundaries 115 and the sizes of the regions 111, 112, 113, and 114 by controlling the image processing section 40.

In an example shown in FIG. 4B, the region 111 is enlarged and the display size of the displayed image P1 displayed in the region 111 is increased. The region 114 is reduced and the displayed images P2 are displayed in a size reduced while maintaining an aspect ratio. Therefore, a margin section 116 is formed in the region 114. The regions 112 and 113 reduced by the movement of the region boundaries 115 are regions where images are not displayed. Therefore, the displayed images in the regions 112 and 113 do not change.

In the example shown in FIG. 4B, the region boundary 115 between the region 112 and the region 113 does not move. That is, in the example shown in FIG. 4B, the region boundary 115 extending in the lateral direction and the region boundary 115 extending in the longitudinal direction are divided at a crossing point of the region boundaries 115 and are individually movable. Therefore, as shown in FIG. 4B, a half of the region boundary 115 extending in the lateral direction does not move in the longitudinal direction. This configuration is an example. Naturally, it is also possible to adopt a configuration in which both of the region boundary 115 extending in the lateral direction and the region boundary 115 extending in the longitudinal direction are not divided.

In the regions 111, 112, 113, and 114, it is possible to perform drawing according to operation by the pointer 70. In this embodiment, drawing can be performed in both of the regions 111, 113, and 114, which are the apparatus associated regions, and the region 112, which is the processing region.

When the drawing is performed, the user performs operation for calling a menu bar M using the pointer 70. This operation is, for example, operation for bringing the distal end portion 71 into contact with the screen SC at any one point in a drawing region and keeping the pointer 70 stationary for a predetermined time. When the operation acquiring section 32 detects this operation, the projection control section 31 displays the menu bar M in a region where the operation is performed.

In the menu bar M, icons for instructing drawing of a straight line, drawing of a curved line, and drawing of a circle and a polygon such as a square are arranged. In the menu bar M, icons for selecting a drawing color of a line and a figure to be drawn, thickness of the line, and a paint-out color, icons for instructing erasing of the drawn line and figure, and the like are arranged. When the user selects the icon with operation by the pointer 70 and moves the pointer 70 to draw a figure, the operation acquiring section 32 draws the figure on the basis of a track of the distal end portion 71. In FIG. 4C, an example is shown in which the menu bar M is displayed in the region 111 and a drawn image P3 is drawn. When the drawing is performed in this way, the drawn image P3, which is a drawn image object, can be processed together with other image objects included in the displayed image P1 already displayed in the region 111.

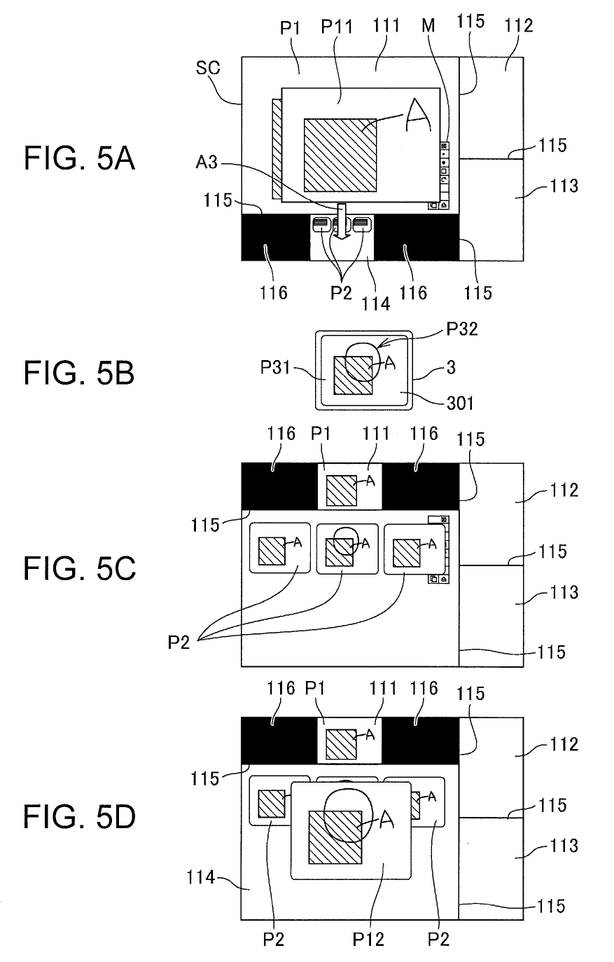

FIGS. 5A, 5C, and 5D show an example in which display changes according to operation by the pointer 70. FIG. 5B shows a display example in the tablet 3.

When capture of an image displayed in the region 111 is instructed by the pointer 70 in the state shown in FIG. 4C, as shown in FIG. 5A, the control section 30 generates a captured image P11 of the entire region 111 including the displayed image P1 and the drawn image P3. The captured image P11 is generated by clipping an image corresponding to the region 111 from the frame memory 41. The region 111 is associated with the tablet 2. The displayed image P1 based on image data received from the tablet 2 by the projector 100 is displayed in the region 111. In other words, an image source of the displayed image P1 displayed in the region 111 is set to the tablet 2. Processing performed on the displayed image P1 by the projector 100 is limited to processing for superimposing the drawn image P3 and a change of a display size involved in enlargement and reduction of the region 111.

On the other hand, the captured image P11 is a still image generated by the control section 30 from image data of the frame memory 41 and is not associated with the tablet 2. Therefore, the captured image P11 can be transmitted and stored or subjected to various kinds of image processing according to the control by the control section 30.

When operation for moving the pointer 70 as indicated by an arrow A3 is performed on the captured image P11, the control section 30 moves the captured image P11 to the region 114. This operation is operation for bringing the distal end portion 71 into contact with the screen SC on the captured image P11 and directly moving the distal end portion 71 to the region 114 in the direction of the arrow A3.

The region 114 is an apparatus associated region (a plural-apparatuses associated region) associated with the plurality of tablets 3. The control section 30 transmits, according to the operation in FIG. 5A, image data of the captured image P11 to the tablet 3 associated with the region 114. The tablet 3 receives the image data transmitted by the projector 100 and displays an image based on the received image data on the touch panel 301. Consequently, as shown in FIG. 5B, the drawn image P31 same as the captured image P11 is displayed on the touch panel 301 of the tablet 3.

Each of the plurality of tablets 3 transmits the image data of the displayed drawn image P31 to the projector 100. During display of an image, the tablet 2 and the tablets 3 may transmit image data corresponding to the displayed image to the projector 100 at every predetermined time. The transmission of the image data may be performed when the image displayed on the touch panel 301 is updated or when the image data is received from the projector 100.

The control section 30 updates, on the basis of the image data transmitted from the tablet 3, the image displayed in the region 114.

In FIG. 5C, a state in which a projected image on the screen SC is updated. In the state shown in FIG. 5C, the region 114 is enlarged by operation by the pointer 70.

In FIG. 5C, the displayed images P2 are updated according to the update of the displayed image on the touch panel 301 in the respective tablets 3.

Further, as shown in FIG. 5B, in the tablet 3, an image can also be drawn according to operation of the touch panel 301. In this case, the control section 312 of the tablet 3 detects, with the input section 314, the operation on the touch panel 301, generates an image on the basis of an instruction of drawing and an instruction of drawing content, and displays the generated image over the drawn image P31 already displayed. Consequently, in the touch panel 301, the image received from the projector 100 and the drawn image are combined and a drawn image P32 is generated and displayed.

The tablet 3 transmits image data of the drawn image P32 to the projector 100. As shown in FIG. 5C, the displayed image P2 corresponding to the tablet 3 is updated. In an example shown in FIG. 5C, since the drawing is performed in one tablet 3, the displayed image P2 corresponding to the tablet 3 is updated.

In the region 114, it is possible to select any one displayed image P2 among the displayed images P2 corresponding to the plurality of tablets 3 and generate a captured image. In FIG. 5D, an example is shown in which one displayed image P2 is selected and a captured image P12 is generated. The captured image P12 is an image clipped from the frame memory 41 by the control section 30. The region 114 is associated with the tablet 3. However, the captured image P12 is a still image not limited by association with an apparatus. The control section 30 can transmit and store the captured image P12 and perform other image processing on the captured image P12.

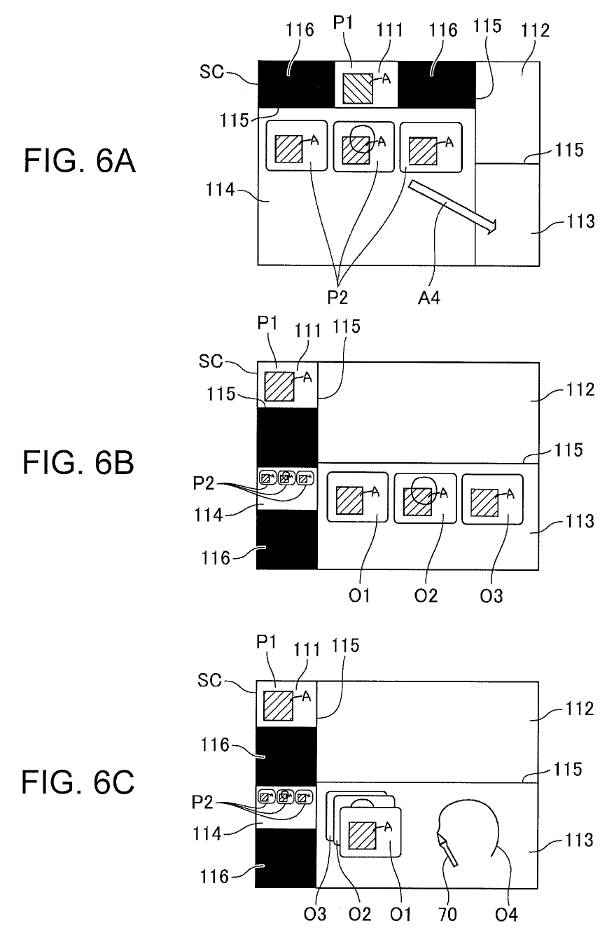

FIGS. 6A to 6C show an example in which display changes according to operation by the pointer 70.

In FIG. 6A, an example is shown in which operation for moving the pointer 70 from the region 114 to the region 113 as indicated by an arrow A4 is performed. The displayed images P2, which are processing targets, are selected according to prior operation by the pointer 70. In this example, all of the three displayed images P2 are targets.

According to this operation, the control section 30 performs processing for moving the processing target displayed images P2 to the region 113. The control section 30 clips images of the displayed images P2 in the region 113 from the frame memory 41, generates captured images respectively corresponding to the displayed images P2, and displays the captured images in the region 113.

The region 113 is the processing region as explained above. Images and the like displayed in the region 113 can be independently operated as displayed objects. Therefore, as shown in FIG. 6B, the captured images generated from the displayed images P2 are displayed in the region 113 as objects O1 to O3. For example, as shown in FIG. 6C, display positions of the objects O1 to O3 can be changed. In the region 113, it is possible to display the menu bar M and perform drawing according to operation by the pointer 70. In this case, as shown in FIG. 6C, an image drawn in the region 113 is displayed as an object O4. Like the objects O1 to O3, a display position, a display size, and the like of the object O4 can be changed. The object O4 can be individually erased, copied, and stored. Note that, thereafter, when operation for moving the objects O1 to O4 to the region 111 or the region 114 is performed, the control section 30 transmits image data of the objects O1 to O4 to the tablet 2 or the tablets 3.

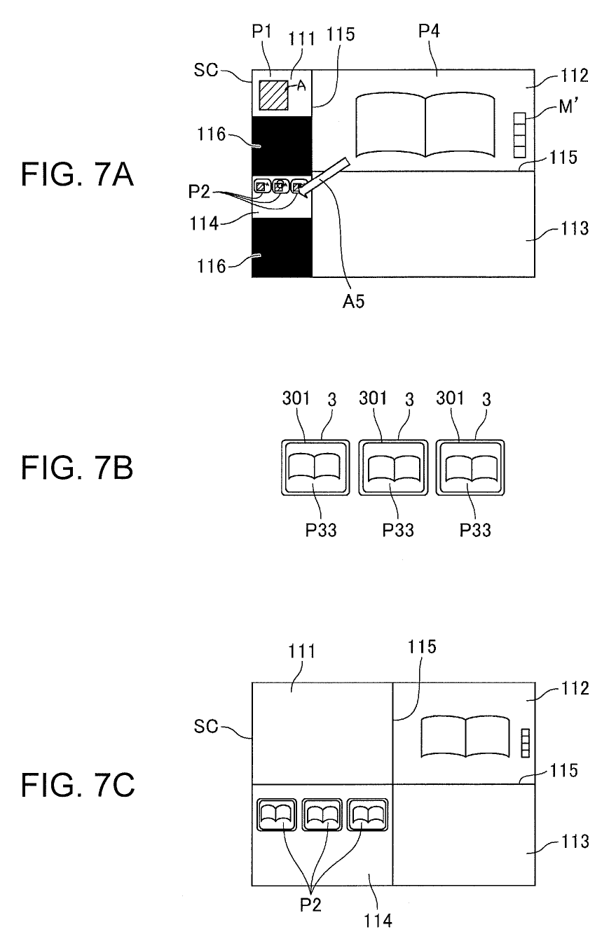

FIGS. 7A and 7C show an example in which display changes according to operation by the pointer 70. FIG. 7B shows a display example in the tablets 3.

FIG. 7A shows an example in which a captured image captured by the document camera 4 is displayed in the region 112. A displayed image P4 in the region 112 is a captured image of the document camera 4. In FIG. 7A, a menu bar M′ is displayed in the region 112 together with the displayed image P4. The menu bar M′ includes icons operable by the pointer 70. The icons correspond to operation of the document camera 4. When the icon of the menu bar M′ is operated, the control section 30 transmits control data corresponding to the operation to the document camera 4 and executes zoom adjustment, stop of display, and the like of the document camera 4.

When operation by the pointer 70 is performed from the region 112 to the region 114 as indicated by an arrow A5 shown in FIG. 7A, the control section 30 performs processing for moving the displayed image P4 in the region 112 to the region 114. The region 114 is the apparatus associated region associated with the tablets 3. Therefore, the control section 30 performs processing for transmitting the displayed image P4 to the tablets 3. In this processing, the control section 30 clips an image of a region corresponding to the displayed image P4 from the frame memory 41, generates a captured image, and transmits image data of the captured image to the tablets 3. The region 112 is associated with the document camera 4. The displayed image P4 is updated according to the operation of the document camera 4. On the other hand, the captured image generated by the control section 30 can be processed as independent image data.

The control section 30 transmits the captured image to all the tablets 3 associated with the region 114. In FIG. 7A, when operation for selecting the displayed image P2 in a part of the region 114 is performed, the control section 30 may transmit image data of the captured image only to the tablet 3 corresponding to the selected displayed image P2.

As shown in FIG. 7B, the tablets 3, to which the captured image is transmitted, update displayed images on the touch panels 301. Drawn images P33, which are captured images of the document camera 4, are displayed on the touch panels 301.

As shown in FIG. 5B as well, when the display is updated in the tablets 3, the display in the region 114 is also updated. A state after the update is shown in FIG. 7C. In an example shown in FIG. 7C, the sizes of the regions 111, 112, 113, and 114 are reset to the initial state.

In the example shown in FIG. 7C, the displayed images P2 respectively corresponding to the respective tablets 3 in the region 114 are updated with an image copied from the region 112. Since the three displayed images P2 corresponding to the three tablets 3 are arranged in the region 114, the displayed images P2 are displayed as thumbnail images. On the other hand, in the region 111, one displayed image P1 corresponding to the tablet 2 only has to be displayed. Therefore, when the displayed image P4 is moved from the region 112 to the region 111, the displayed image P4 in the region 112 is displayed in the entire region 111. That is, although all of the regions 111, 112, and 114 are the apparatus associated regions, one displayed image is displayed on the entire surfaces in the regions 111 and 112 associated with an independent apparatus. Images as many as the apparatuses are displayed in the region 114 corresponding to the plurality of apparatuses. In the region 114, since a display size of one displayed image is small, it is possible to set the thumbnail images to be displayed.

In this way, the control section 30 of the projector 100 can display images in the regions 111, 112, 113, and 114 formed by dividing the projectable region 110, move the displayed images to different regions, and copy the images.

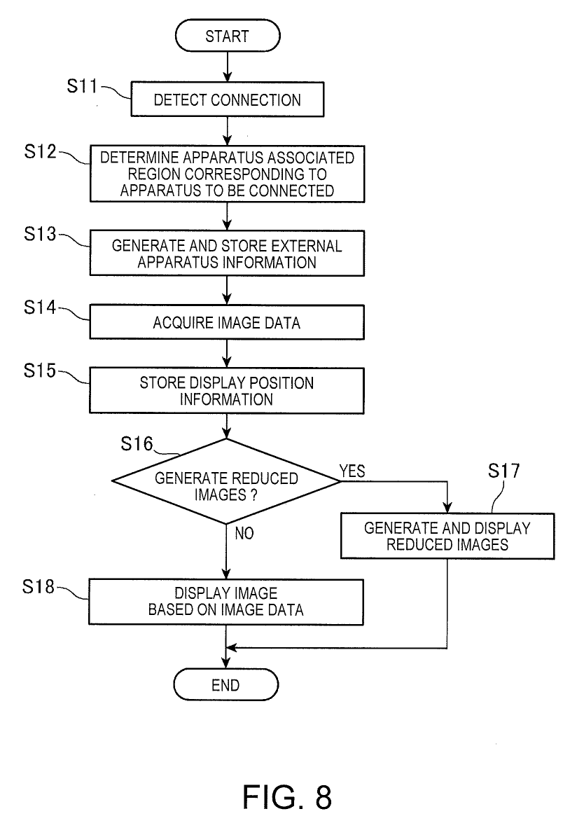

FIGS. 8 to 11 are flowcharts for explaining the operation of the projector 100. FIG. 8 shows connection processing executed when external apparatuses such as the tablets 2 and 3 and the document camera 4 are connected to the projector 100.

The connection processing is executed when the control section 30 detects connection to the interface section 11 or the image interface section 12.

The control section 30 detects connection of an external apparatus to the interface section 11 or the image interface section 12 (step S11) and determines an apparatus associated region corresponding to the connected apparatus (step S12). In this embodiment, the region 111 corresponds to the tablet 2 and the region 112 corresponds to the document camera 4. The region 113 is a plural-apparatuses associated region associated with the plurality of tablets 3. The control section 30 determines, on the basis of a type of the external apparatus detected in step S11, a region associated with the external apparatus among apparatus associated regions on which the projector 100 can perform projection. When a type of an external apparatus that can be associated with the apparatus associated regions is not limited, association with the apparatus associated regions may be performed in order of connection. When there are a plurality of external apparatuses to be connected, the external apparatuses may be determined to be associated with a plural-apparatuses associated region.

The control section 30 acquires, from the connected external apparatus, information concerning the apparatus and stores the information in the storing section 60 as external apparatus information 62 (step S13) and acquires image data from the connected external apparatus (step S14). The control section 30 associates the connected external apparatus and the position of the apparatus associated region determined in step S12, and stores the position in the storing section 60 as the display position information 63 (step S15).

The control section 30 determines whether to generate thumbnail images (step S16). For example, when the region determined in step S12 is a plural-apparatuses associated region, since a display size is small like the region 114 shown in FIG. 4A, the thumbnail images may be used. If the thumbnail images are used (Yes in step S16), the control section 30 generates image data of the thumbnail images from the image data received in step S14 and displays the thumbnail images in the region determined in step S12 (step S17).

If the thumbnail images are not used (No in step S16), the control section 30 displays, in the region determined in step S12, an image based on the image data received in step S14 (step S18).

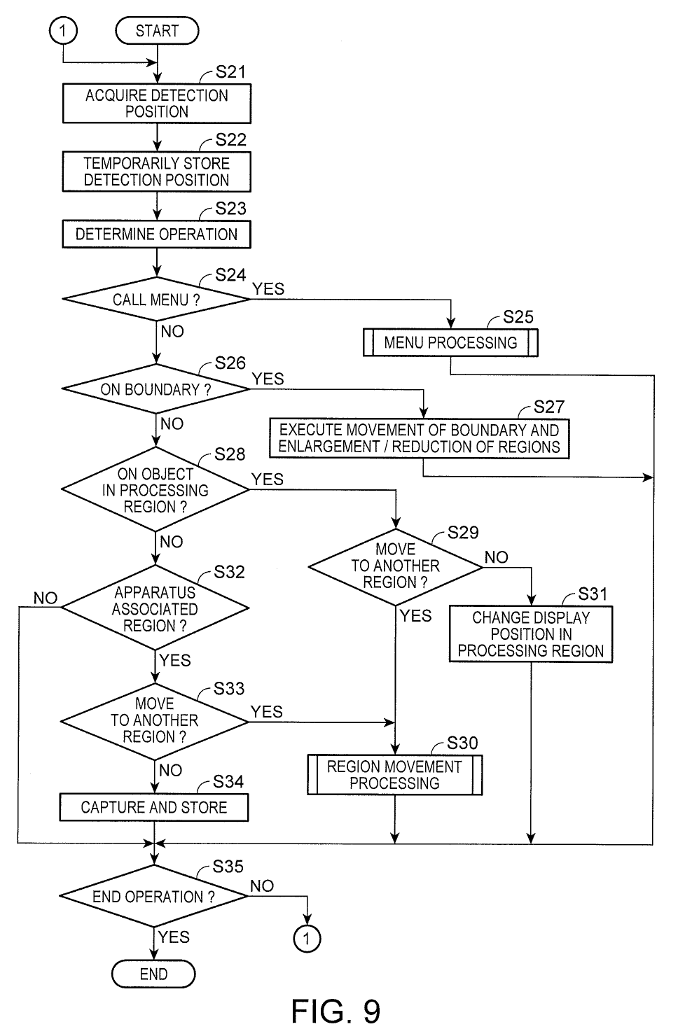

FIG. 9 is a flowchart for explaining an operation related to display of an image.

When the operation detecting section 50 detects operation by the pointer 70, the control section 30 acquires the position of the detected operation (step S21) and temporarily stores the operation position in the RAM or the storing section 60 (step S22).

Subsequently, the control section 30 determines content of the operation (step S23). The content of the operation is, for example, operation for instructing display of a menu bar, operation for instructing movement of the region boundaries 115, and operation for moving an image and an object to be displayed in the projectable region 110.

The control section 30 determines whether the operation content is a call for a menu bar (step S24). If determining that the operation content is the operation of the call for the menu bar (Yes in step S24), the control section 30 executes menu processing (step S25) and shifts to step S35 explained below.

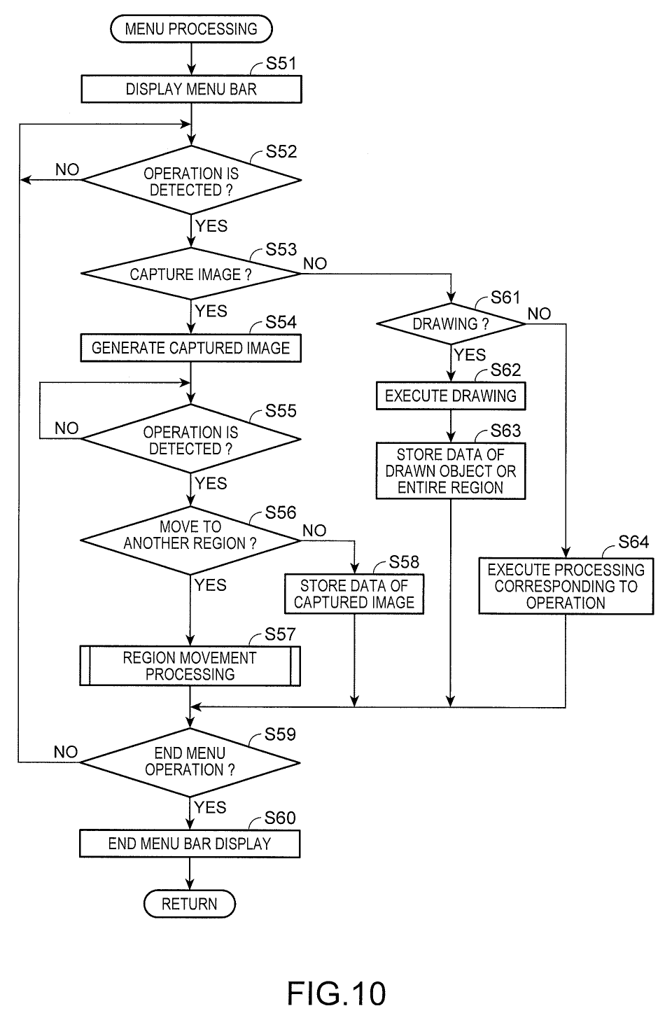

FIG. 10 is a flowchart for explaining in detail the menu processing executed in step S25 of FIG. 9.

The control section 30 displays an image of the menu bar M in a region including the operation position detected in step S21 (FIG. 9) (step S51) and stands by for operation on the menu bar M (step S52).

When detecting operation in the position of the icon of the menu bar M (Yes in step S52), the control section 30 determines whether the detected operation is operation for instructing capture of an image (step S53). The determination in step S53 is performed on the basis of whether an operation position of the pointer 70 is a coordinate on the icon for the capture instruction included in the menu bar M.

If determining that the detected operation is the instruction for the capture of an image (Yes in step S53), the control section 30 generates a captured image of a region where the menu bar M is displayed (step S54) and stands by for operation related to processing of the captured image (step S55).

If detecting the operation by the pointer 70 (Yes in step S55), the control section 30 determines whether content of the detected operation is operation for instructing movement of the image to another region (step S56). If determining that the content of the detected operation is the operation for instructing movement of the image to another region (Yes in step S56), the control section 30 executes region movement processing for moving the image to another region (step S57) and shifts to step S59. The region movement processing is explained below.

If determining that the content of the detected operation is not the operation for instructing movement of the image to another region (No in step S56), the control section 30 stores data of the captured image in the storing section 60 (step S58) and shifts to step S59.

In step S59, the control section 30 determines whether the operation of the menu bar M ends. When detecting operation for instructing an end of the display of the menu bar M or when detecting operation on a region where the menu bar M is not displayed, the control section 30 determines that the operation of the menu bar M ends (Yes in step S59). In this case, the control section 30 ends the display of the menu bar M (step S60) and ends the processing.

If determining that the operation of the menu bar M does not end (No in step S59), the control section 30 return to step S52 and stands by for operation.

On the other hand, if the operation detected during the display of the menu bar M is not the instruction for the capture of an image (No in step S53), the control section 30 determines whether the operation detected during the display of the menu bar M is an instruction for drawing (step S61). If determining that the operation detected during the display of the menu bar M is the instruction for drawing (Yes in step S61), the control section 30 detects operation by the pointer 70 performed thereafter and executes drawing according to a track of an operation position (step S62). The control section 30 generates image data of a drawn object or an entire drawn region and stores the image data in the storing section 60 (step S63). When a target region of the menu processing in FIG. 10 is an apparatus associated region, in step S63, the control section 30 generates image data of the entire drawn region and stores the image data. In this case, the generated image data includes an image input from an external apparatus and displayed. When the target region of the menu processing is a processing region, in step S63, the control section 30 generates image data of the drawn object and stores the image data. After executing the processing of step S63, the control section 30 shifts to step S59.

If operation other than the drawing is performed by the pointer 70 (No in step S61), the control section 30 executes processing corresponding to content of the operation (step S64) and shifts to step S59. The processing executed in step S64 is, for example, processing for erasing the drawn object, setting processing related to drawing such as a shape, a color, and thickness of a line of a figure to be drawn, and processing for moving the object in a region.

Referring back to FIG. 9, if determining in step S23 that the operation content is not the operation of the call of the menu bar (No in step S24), the control section 30 determines whether the operation position is on the region boundary 115 (step S26). When the operation by the pointer 70 is continuous and the operation position temporarily stored in step S22 forms one track, the control section 30 determines whether a start point of the track is on the region boundary 115 or a position close to the region boundary 115. If the operation position is on the region boundary 115 (Yes in step S26), the control section 30 performs processing for moving the region boundary 115 following a track of the operation by the pointer 70 (step 27). In step S27, the control section 30 performs, according to the processing for moving the region boundary 115, processing for enlarging and reducing the regions 111, 112, 113, and 114 on the basis of the position of the region boundary 115 after the movement. Thereafter, the control section 30 shifts to step S35 explained below.

If determining that the operation position is not on the region boundary 115 (No in step S26), the control section 30 determines whether the operation position is on an object in the region 113, which is the processing region (step S28). If determining that the operation position is on the object in the region 113, which is the processing region (Yes at step S28), the control section 30 determines whether the operation by the pointer 70 is operation for instructing movement of the object to another region (step S29). For example, when the operation by the pointer 70 is continuous and the operation position temporarily stored in step S22 forms one track, the control section 30 determines whether an end point of the track is another region. If determining that the operation by the pointer 70 is the operation for instructing movement of the object to another region (Yes in step S29), the control section 30 executes region movement processing (step S30) and shifts to step S35. Details of the region movement processing are explained below.

If determining that the operation by the pointer 70 is not the operation for instructing movement of the object to another region (No in step S29), the control section 30 moves the object in the processing region according to the operation (step S31). That is, the control section 30 performs processing for changing a display position of the object and shifts to step S35.

On the other hand, if determining that the operation position of the pointer 70 is not on the object in the processing region (No in step S28), the control section 30 determines whether the operation position is present in the apparatus associated region (step S32). If the operation position is present in any one of the regions 111, 112, and 114, which are the apparatus associated regions (Yes in step S32), the control section 30 determines whether the operation by the pointer 70 is operation for instructing movement of an image in the apparatus associated region to another region (step S33). If determining that the operation by the pointer 70 is the operation for instructing movement the image to another region (Yes in step S33), the control section 30 shifts to step S30 and executes the region movement processing.

If determining that the operation by the pointer 70 is not the operation for instructing movement of the image to another region (No in step S33), the control section 30 captures an image of the region including the operation position, generates a captured image, stores the captured image in the storing section 60 (step S34), and shifts to step S35.

If determining that the operation position is not the apparatus associated region (No in step S32), the control section 30 shifts to step S35.

In step S35, the control section 30 determines whether the operation by the pointer 70 ends. For example, when an operation end is instructed by the pointer 70 or the remote controller (not shown in the figure), the control section 30 determines to end the operation (Yes in step S35). If not to end the operation (No in step S35), the control section 30 returns to step S21.

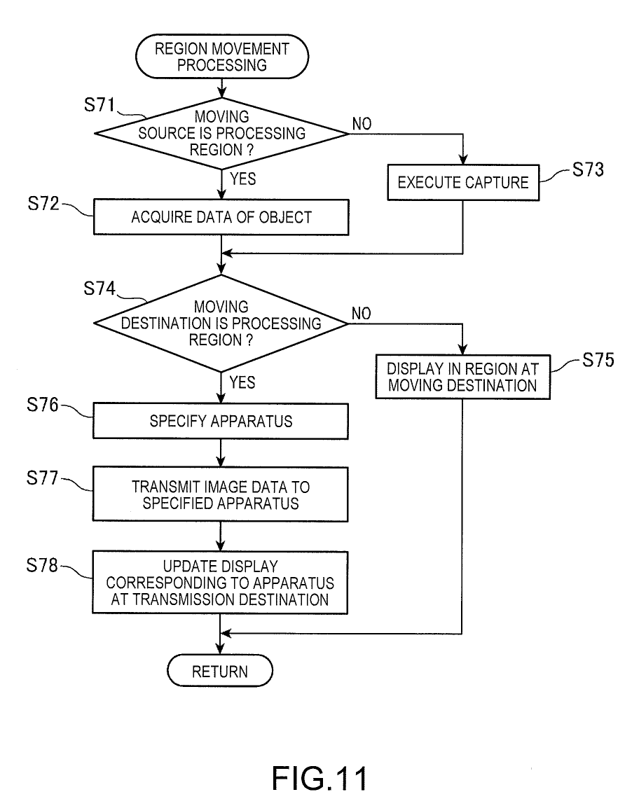

FIG. 11 is a flowchart for explaining the region movement processing in detail. The region movement processing is executed according to operation for moving a displayed image or an object displayed in any one of the regions 111, 112, 113, and 114 in the projectable region 110 to another region.

In the region movement processing, the control section 30 determines whether a region at a moving source is a processing region (step S71). If the moving source is the processing region (Yes in step S71), the control section 30 acquires image data of an object to be moved (step S72). If determining that the moving source is not the processing region (No in step S71), since the region at the moving source is an apparatus associated region, the control section 30 captures a displayed image in the region at the moving source and generates a captured image (step S73). Note that when a captured image is already generated when the region movement processing in FIG. 11 is started, the processing in steps S71 to S73 is omitted.

Subsequently, the control section 30 determines whether a moving destination is a processing region (step S74). If the moving destination is the processing region (Yes in step S74), the control section 30 displays the object to be moved or the captured image in the region at the moving source in the processing region at the moving destination as an object (step S75) and ends the processing.

On the other hand, if the moving destination is not the processing region (No in step S74), since the moving destination is an apparatus associated region, the control section 30 specifies an apparatus associated with the region at the moving destination referring to the display position information 63 (step S76). The control section 30 transmits, to the apparatus specified in step S76, image data of the object to be moved or the captured image in the region at the moving source (step S77). Further, the control section 30 updates display in the region at the moving destination using the object to be moved or the captured image in the region at the moving source (step S78) and ends the processing.

In step S78, the control section 30 may update the display using the image data transmitted in step S77. When the external apparatus at the transmission destination in step S77 transmits, after receiving the image data, image data of a displayed image to the projector 100, the control section 30 may receive the image data and updates a projected image on the screen SC.

As explained above, the display system 1 according to the embodiment applied with the invention includes the projector 100 and the tablets 2 and 3 and the document camera 4 functioning as the external apparatuses connected to the projector 100. The external apparatuses output images to the projector 100. The projector 100 includes the projecting section 20 that displays an image in the projectable region 110, the interface section 11 and the image interface section 12 connected to the external apparatuses, and the operation detecting section 50 that detects operation by the pointer 70. The projector 100 provides the plurality of regions 111, 112, 113, and 114 in the projectable region 110 and includes the control section 30 that causes the projecting section 20 to display images in the respective regions. The plurality of regions include the apparatus associated regions associated with the external apparatuses to display images concerning the external apparatuses and the processing region where processing for an image displayed in the region is possible. The control section 30 causes the projecting section 20 to display images input by the external apparatuses in the apparatus associated regions and causes, according to operation detected by the operation detecting section 50, the projecting section 20 to display an image displayed in any one of the regions in another region.

Therefore, it is possible to perform processing on images displayed in the regions associated with the external apparatuses using the pointer 70. By displaying the images in the regions associated with the external apparatuses in the processing region and performing processing, it is possible to display a plurality of images and perform processing for the image to be displayed without affecting association of the external apparatuses and the displayed images.

The control section 30 of the projector 100 causes the projecting section 20 to display images in the apparatus associated regions in forms associated with the external apparatuses. When the operation detecting section 50 detects operation for moving the images to be displayed in the apparatus associated regions to the processing region, it is possible to change the display forms of the operated images. Consequently, it is possible to change the display forms concerning the images in the regions associated with the external apparatuses without affecting the association of the external apparatus and the image.

When the operation detecting section 50 detects operation for moving the image to be displayed in the processing region to the apparatus associated regions, the control section 30 performs, on the operated image, processing related to the external apparatus associated with the apparatus associated region at a moving destination (e.g., processing for transmitting image data to the external apparatus). Consequently, it is possible to execute the processing related to the external apparatuses according to operation for moving an image. It is possible to attain improvement of convenience.

The operation detecting section 50 detects operation on the projectable region 110 of the screen SC. When the operation detecting section 50 detects operation across the processing region and the apparatus associated regions, the control section 30 detects the operation as operation for moving the image to be displayed in the processing region to the apparatus associated region or operation for moving the image to be displayed in the apparatus associated region to the processing region. Consequently, the user can instruct processing for moving an image to be displayed in a region to another region by performing operation across the plurality of regions.

The control section 30 is capable of associating a plurality of the external apparatuses with at least one apparatus associated region and setting the apparatus associated region as a plural-apparatuses associated region. When the operation detecting section 50 detects operation for moving an image to the plural-apparatuses associated region, the control section 30 performs processing related to each of the plurality of external apparatuses associated with the plural-apparatuses associated region at a moving destination (e.g., processing for transmitting image data to each of the plurality of external apparatuses). Therefore, the user can execute processing related to the plurality of external apparatuses by performing simple operation.

The control section 30 causes the projecting section 20 to display, in displays positions associated with the respective external apparatuses, images input from the plurality of external apparatuses associated with the plural-apparatuses associated region. For example, the control section 30 causes the projecting section 20 to display images based on image data transmitted from the plurality of tablets 3 in positions corresponding to the tablets 3 in the region 114. Consequently, when the plurality of external apparatuses input images, it is possible to clearly display the plurality of images.

The projector 100 displays, with the projecting section 20, in the apparatus associated region or the processing region, an image input from the external apparatus connected to the interface section 11. The control section 30 is capable of changing, without being limited by the external apparatus that inputs the image to be displayed, at least one of a display position and a display size of the image displayed in the processing region by the projecting section 20. For example, an image moved to the region 113, which is the processing region, is displayed as an object. The control section 30 can change a display position and a display size of the object. In this way, in the projector 100, it is possible to change the display position and the display size of the displayed image in the processing region without being restricted concerning the external apparatus associated with the apparatus associated region.

The external apparatus connected to the projector 100 includes an image input apparatus that inputs an image to the interface section 11. The projecting section 20 displays the image input by the image input apparatus in the apparatus associated region associated with the image input apparatus. In this embodiment, an image transmitted by the tablet 2 is displayed in the region 111, an image transmitted by the document camera 4 is displayed in the region 112, and an image transmitted by the tablet 3 is displayed in the region 114. In this way, the projector 100 can process images according to the external apparatuses that input the images.

In the projector 100, the external apparatus includes an image input/output apparatus capable of inputting and outputting an image via the interface section 11. The projecting section 20 displays the image input by the image input/output apparatus in the apparatus associated region associated with the image input/output apparatus. When the operation detecting section 50 detects operation for moving an image to the apparatus associated region, the control section 30 outputs the image to the image input/output apparatus associated with the apparatus associated region at a moving destination.

According to the invention, it is possible to process an image input by the external apparatus and output an image to the external apparatus.

The control section 30 performs processing according to operation for moving an image from the first apparatus associated region to the processing region and is capable of further processing the processed image when the operation detecting section 50 detects operation for moving the processed image to the second apparatus associated region. In this processing, the control section 30 is capable performing the processing without being restricted concerning the external apparatus associated with the first apparatus associated region. For example, when the displayed image P2 is moved from the region 114 to the region 113 in FIG. 6A, the captured images of the displayed images P2 are displayed in the region 113 as the objects O1 to O3. When operation for moving the objects O1 to O3 to the region 111 or the region 114 is performed, the control section 30 transmits image data of the objects O1 to O3 to the tablet 2 or the tablets 3. The objects O1 to O3 are objects based on the image data of the displayed images of the tablets 3. This does not affect the processing for transmitting the image data of the objects O1 to O3. Therefore, the images moved to the region 113, which is the processing region, and displayed as the objects O1 to O3 can be processed at a high degree of freedom without being affected by an attribute and the like of the external apparatus. Therefore, in a configuration in which different types of external apparatuses are connected to the projector 100, it is possible to utilize images input from the external apparatuses.

Note that the embodiment and the modifications explained above are only examples of specific forms applied with the invention and do not limit the invention. The invention can be applied as different forms. For example, the pointer used in the operation on the projectable region 110 is not limited to the pointer 70 of a pen type. A finger of the user, a laser pointer, a pointing rod, and the like may be used. The shape and the size of the pointer are not limited.

In the embodiment, the operation detecting section 50 images the screen SC with the imaging section 51 and specifies the position of the pointer 70. However, the invention is not limited to this. The imaging section 51 is not limited to an imaging section provided in a main body of the projector 100 to image in a projecting direction of the projection optical system 23. The imaging section 51 may be disposed separately from the main body of the projector 100. The imaging section 51 may perform imaging from a side or the front of the screen SC. Further, a plurality of the imaging sections 51 may be disposed. The target detecting section 54 may detect an operation position on the basis of captured image data of the plurality of imaging sections 51.

In the embodiment, the configuration is explained in which the signal for synchronization is transmitted from the projector 100 to the pointer 70 using the infrared ray signal emitted by the transmitting section 52. However, the signal for synchronization is not limited to the infrared ray signal. For example, the signal for synchronization may be transmitted by radio wave communication or ultrasonic wireless communication.

In the embodiment, the example is explained in which it is determined on the basis of the lighting pattern of the transmitting and receiving section 74 whether the distal end portion 71 of the pointer 70 is in contact with the screen SC. However, the invention is not limited to this. For example, it may be determined on the basis of images of the pointer 70 and the distal end portion 71 reflected in captured image data whether the distal end portion 71 of the pointer 70 is pressed against the screen SC. This configuration can be realized by, for example, detecting the position of the distal end portion 71 on the basis of a plurality of captured image data captured from different directions or detecting an image of the distal end portion 71 and an image of a shadow of the pointer 70 from the captured image data.

In the embodiment, the example is explained in which the operation by the pointer 70 is detected by the function of the operation detecting section 50 incorporated in the projector 100. However, the invention is not limited to this. For example, the function of the operation detecting section 50 can also be realized as an apparatus independent from the projector 100. It is also possible to realize a form in which the function of the operation detecting section 50 is imparted to a display apparatus other than the projector 100 and the display apparatus is caused to operate as a position detecting device.

The display apparatus according to the invention is not limited to the projector 100 that projects an image on the screen SC as explained above. Various display apparatuses such as a liquid crystal monitor or a liquid crystal television that displays an image on a liquid crystal display panel, a monitor apparatus or a television receiver that displays an image on a PDP (Plasma Display Panel), and a display apparatus of a self-emitting type such as a monitor apparatus or a television receiver that displays an image on an organic EL display panel called OLED (Organic light-emitting diode), OEL (Organic Electro-Luminescence), or the like are also included in the display system according to the invention. In this case, the liquid crystal panel, the plasma display panel, and the organic EL display panel are equivalent to the display section and the display surface. The display surface is equivalent to the display region, the operation surface operated by the pointer 70, and the operation region.

In the embodiment, as the light modulating device 22 that modulates the light emitted by the light source, the configuration including the three transmission-type liquid crystal panels corresponding to the colors or RGB is explained as an example. However, the invention is not limited to this. For example, the light modulating device 22 may be a configuration including three reflection-type liquid crystal panels. A system in which one liquid crystal panel and a color wheel are combined may be used. The light modulating device 22 may be configured by a system in which three digital mirror devices (DMDs) are used, a DMD system in which one digital mirror device and a color wheel are combined, or the like. When only one liquid crystal panel or DMD is used as the light modulating device 22, a member equivalent to a combined optical system such as a cross dichroic prism is unnecessary. Besides the liquid crystal panel and the DMD, a light modulating device capable of modulating the light emitted by the light source can be adopted without problems.

The functional blocks shown in the functional block diagrams of FIGS. 2 and 3 indicate the functional configurations of the tablet 2 and 3, the document camera 4, and the projector 100. Specific implementation forms of the functional blocks are not limited. That is, hardware corresponding to the functional blocks in the figure does not need to be mounted. Naturally, it is possible to adopt a configuration in which one processor executes a computer program to realize functions of a plurality of functional sections. Apart of the functions realized by software in the embodiment may be realized by hardware or a part of the functions realized by hardware may be realized by software.

Further, the external apparatuses connectable to the projector 100 are not limited to the tablets 2 and 3 and the document camera 4. The external apparatuses only have to be, for example, apparatuses capable of outputting images and sound such as a desktop computer, a cellular phone including a smart phone, a video/music player, and a tuner apparatus of television broadcast. A specific configuration of the interfaces that connect the external apparatuses and the projector 100 is not limited. Interfaces capable of transmitting an analog image signal, a sound signal, or digital data can be applied without limitation. Besides, specific detailed configurations of the other sections of the apparatuses configuring the display system 1 can be arbitrarily changed without departing from the spirit of the invention.

What is claimed is:

1. A display apparatus comprising:
a display section configured to display an image in a display region;
a connecting section connected to an external apparatus;
an operation detecting section configured to detect operation; and
a control section configured to provide a plurality of regions in the display region and cause the display section to display images respectively in the plurality of regions, wherein
the plurality of regions include an apparatus associated region associated with the external apparatus to display an image concerning the external apparatus and a processing region where processing for the image displayed in the region is possible,
the control section causes, according to the operation detected by the operation detecting section, the display section to display an image displayed in any one of the regions in another one of the regions.

2. The display apparatus according to claim 1, wherein the control section causes the display section to display an image in the apparatus associated region in a form associated with the external apparatus and is capable of changing, when the operation detecting section detects operation for moving the image to be displayed in the apparatus associated region to the processing region, the display form of the operated image.

3. The display apparatus according to claim 1, wherein, when the operation detecting section detects operation for moving the image to be displayed in the processing region to the apparatus associated region, the control section performs, on the operated image, processing related to the external apparatus associated with the apparatus associated region at a moving destination.

4. The display apparatus according to claim 1, wherein
the operation detecting section detects operation on the display region, and
when the operation detecting section detects operation across the processing region and the apparatus associated region, the control section detects the operation as operation for moving the image to be displayed in the processing region to the apparatus associated region or operation for moving the image to be displayed in the apparatus associated region to the processing region.

5. The display apparatus according to claim 1, wherein
the control section is capable of associating a plurality of the external apparatuses with at least a singularity of the apparatus associated region and setting the apparatus associated region as a plural-apparatuses associated region, and
when the operation detecting section detects operation for moving an image to the plural-apparatuses associated region, the control section performs processing related to each of the plurality of external apparatuses associated with the plural-apparatuses associated region at a moving destination.

6. The display apparatus according to claim 5, wherein, when causing the display section to display, in the plural-apparatuses associated region, images input from the plurality of external apparatuses associated with the plural-apparatuses associated region, the control section causes the display section to display the images in display positions corresponding to the respective external apparatuses.

7. The display apparatus according to claim 1, wherein
the display section displays, in the apparatus associated region or the processing region, an image input from the external apparatus connected to the connecting section, and
the control section is capable of changing, without being limited by the external apparatus that inputs the image to be displayed, at least one of a display position and a display size of the image displayed in the processing region by the display section.

8. The display apparatus according to claim 1, wherein
the external apparatus includes an image input apparatus that inputs an image to the connecting section, and
the display section displays the image input by the image input apparatus in the apparatus associated region associated with the image input apparatus.

9. The display apparatus according to claim 1, wherein
the external apparatus includes an image input/output apparatus capable of inputting and outputting an image via the connecting section,
the display section displays the image input by the image input/output apparatus in the apparatus associated region associated with the image input/output apparatus, and
when the operation detecting section detects operation for moving an image to the apparatus associated region, the control section outputs the image to the image input/output apparatus associated with the apparatus associated region at a moving destination.

10. The display apparatus according to claim 1, wherein
the control section performs processing according to operation for moving an image from the first apparatus associated region to the processing region and is capable of processing the processed image without being restricted concerning the external apparatus associated with the first apparatus associated region when the operation detecting section detects operation for moving the processed image to the second apparatus associated region.

11. A display system comprising:
a display apparatus; and
an external apparatus connected to the display apparatus, wherein
the external apparatus outputs an image to the display apparatus,
the display apparatus includes:
a display section configured to display an image in a display region;
a connecting section connected to the external apparatus; an operation detecting section configured to detect operation; and
a control section configured to provide a plurality of regions in the display region and cause the display section to display images respectively in the plurality of regions,
the plurality of regions include an apparatus associated region associated with the external apparatus to display an image concerning the external apparatus and a processing region where processing for the image displayed in the region is possible, and
the control section causes the display section to display the image input by the external apparatus in the apparatus associated region and causes, according to the operation detected by the operation detecting section, the display section to display an image displayed in any one of the regions in another one of the regions.

12. A control method for controlling a display apparatus including a display section that displays an image in a display region and connected to an external apparatus, the control method comprising:
providing, in the display region, a plurality of regions including an apparatus associated region associated with the external apparatus to display an image concerning the external apparatus and a processing region where processing for the image displayed in the region is possible;
displaying images respectively in the plurality of regions;
detecting operation; and
displaying, according to the detected operation, an image displayed in any one of the regions in another one of the regions.

13. A computer program executable by a computer that controls a display apparatus including a display section that displays an image in a display region and connected to an external apparatus, the computer program causing the computer to execute:
providing, in the display region, a plurality of regions including an apparatus associated region associated with the external apparatus to display an image concerning the external apparatus and a processing region where processing for the image displayed in the region is possible;
causing the display section to display images respectively in the plurality of regions; and
displaying, according to operation, an image displayed in any one of the regions in another one of the regions.
